(19) United States
(12) Patent Application Publication
(10) Pub. No.: US 2023/0334477 A1
(43) Pub. Date: Oct. 19, 2023

(54) Currency Conversion System and Method

(71) Applicant: Safe Take Cash (Pty) Ltd., The Wilds (ZA)

(72) Inventor: Alwyn Van der Merwe, The Wilds (ZA)

(21) Appl. No.: 18/022,325

(22) PCT Filed: Aug. 19, 2021
(86) PCT No.: PCT/IB2021/057633

§ 371 Date: Feb. 21, 2023

(30) Foreign Application Priority Data
Aug. 19, 2020 (ZA) 2020/05124

(51) Int. Cl. G06Q 20/38; G06Q 20/32; G07D 11/30; G06Q 20/10

(52) U.S. Cl. CPC G06Q 20/381; G06Q 20/108; G06Q 20/3223; G07D 11/30

(57) ABSTRACT

Disclosed herein is a currency conversion and banknote suspension and reinstatement system and method. A user terminal captures a banknote monetary value of a banknote belonging to a user. A banknote server detaches the banknote monetary value from the banknote by converting the banknote monetary value to a digital monetary value. The use of the banknote is thereby suspended. A bank server credits a bank account of the user by the banknote monetary value. The banknote server restores the banknote monetary value to the banknote by reverse converting the digital monetary value to the banknote monetary value. The use of the banknote is thereby reinstated. The bank server debits the bank account of the user by the banknote monetary value.

### TECHNICAL FIELD

The present disclosure relates generally to techniques for currency conversion. More specifically, the present techniques relate to banknote suspension and reinstatement.

### BACKGROUND ART

Banknote neutralization methods render cash unusable by marking banknotes with a degradation agent. For example, ink may be used to stain banknotes to flag the banknotes as stolen. Furthermore, these methods are implemented by sophisticated systems.

### BRIEF DESCRIPTION OF THE DRAWINGS

FIG. 1 is a schematic illustration of a system for currency conversion and banknote suspension and reinstatement.

FIG. 2 is a schematic diagram of a method for converting currency and suspending and reinstating a banknote implemented by the system shown in FIG. 1.

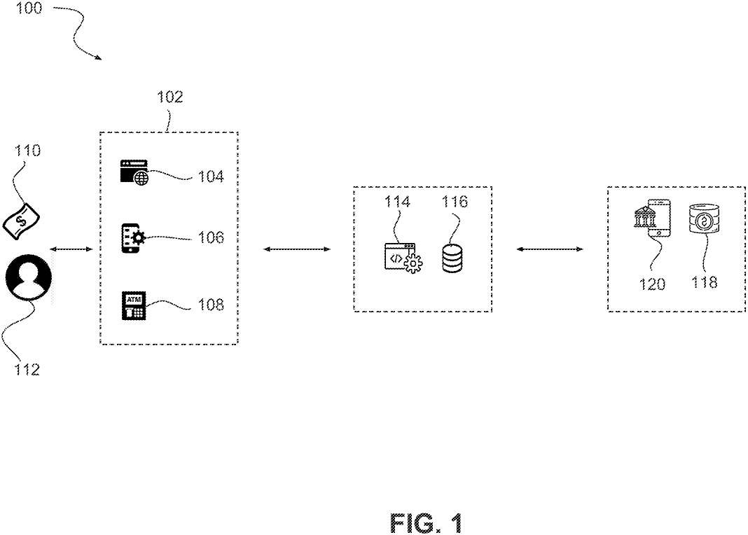

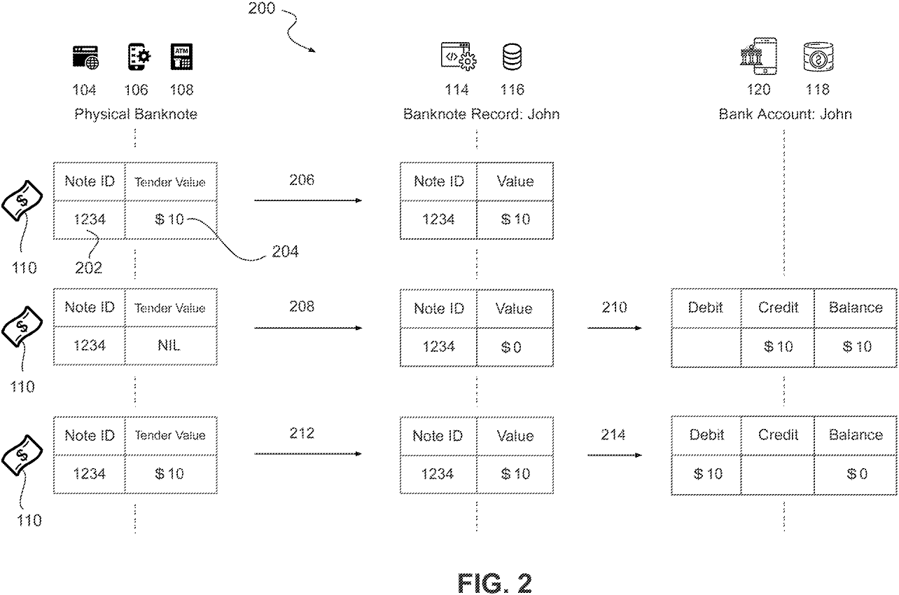

The same numbers are used throughout the disclosure and the figures to reference like features. Numbers in the 100 series refer to features originally found in FIG. 1 and numbers in the 200 series refer to features found in FIG. 2.

### DESCRIPTION OF THE EMBODIMENTS

The currency conversion method disclosed herein involves banknote suspension and reinstatement. The present method neutralizes banknotes, but does not mark them with a degradation agent. As a result, the banknotes remain usable. The present method entails communication between a user terminal and a banknote server and communication between the banknote server and a bank server. No sophisticated system is required. Hence, the present method is an improvement over the banknote neutralization methods described above.

The subject matter disclosed herein relates to techniques for converting currency and suspending and reinstating banknotes. For example, a user terminal may capture a unique banknote identifier and a banknote monetary value of a banknote belonging to a user. A first instruction may be sent from the user terminal to a banknote server. When the first instruction is received by the banknote server, the banknote monetary value may be detached from the banknote by converting the banknote monetary value into a digital monetary value. Use of the banknote may be suspended and the banknote may be unusable as payment at a Point-of-Sale (POS) terminal. A credit request may be sent from the banknote server to a bank server via a bank server interface. When the credit request is received by the bank server, a bank account of the user may be credited by the banknote monetary value. A second instruction may be sent from the user terminal to the banknote server. When the second instruction is received by the banknote server, the banknote monetary value may be restored to the banknote by reverse converting the digital monetary value to the banknote monetary value. Use of the banknote may be reinstated and the banknote may be usable as payment at a POS terminal. A debit request may be sent from the banknote server to the bank server via the bank server interface. When the debit request is received by the bank server, the bank account of the user may be debited by the banknote monetary value. Various examples of the present techniques are described below with reference to the figures.

FIG. 1 is a schematic illustration of a system for currency conversion and banknote suspension and reinstatement. The system 100 may include a user terminal 102. The user terminal 102 may be a user computer 104, a user mobile device 106 or a bank terminal 108. For example, the bank terminal 108 may be an Automated Teller Machine (ATM).

A client-side currency conversion software application may be installed on the user terminal 102. The client-side currency conversion software application may be a desktop application, a browser-based application or the like when the user terminal 102 is a user computer 104 and the client-side currency conversion software application may be a mobile device application or the like when the user terminal 102 is a user mobile device 106.

In addition to the user computer 104 and the user mobile device 106, the user terminal 102 may be a bank terminal 108 or the like. For example, the bank terminal 108 may be an Automated Teller Machine (ATM) or the like.

The user terminal 102 may capture a unique banknote identifier and a banknote monetary value of a banknote 110 belonging to a user 112. A banknote record may be created and may include the unique banknote identifier, the banknote monetary value, the identity of the user 112 or the like. The banknote record may be stored on a banknote server 114 in data communication with a banknote database 116.

The user terminal 102 may send a first instruction to the banknote server 114. In response to the first instruction, the banknote server 114 may detach the banknote monetary value from the banknote 110 by converting the banknote monetary value to a digital monetary value. Use of the banknote 110 may be suspended and the banknote 110 may be unusable as payment at a POS terminal. The banknote record may be updated when the banknote monetary value is detached from the banknote 110.

The banknote server 114 may send a credit request to the bank server 118 via a bank server interface that has a front-end browser interface and a back-end server interface. In response to the credit request, a bank server 118 may credit the bank account of the user 112 by the banknote monetary value. The bank account of the user 112 may be stored on the bank server 118 and accessed via a mobile banking application 120 integrated with the client-side currency conversion software application.

The user terminal 102 may send a second instruction to the banknote server 114. In response to the second instruction, the banknote server 114 may restore the banknote monetary value to the banknote 110 by reverse converting the digital monetary value to the banknote monetary value. Use of the banknote 110 may be reinstated and the banknote 110 may be usable as payment at a POS terminal. The banknote record may be updated when the banknote monetary value is restored to the banknote 110.

The banknote server 114 may send a debit request to the bank server 118 via the bank server interface. In response to the debit request, the bank account of the user 112 may be accessed by the mobile banking application 120 integrated with the client-side currency conversion software application and the bank account of the user 112 may be debited by the banknote monetary value.

FIG. 2 is a schematic diagram of a method for converting currency and suspending and reinstating a banknote implemented by the system shown in FIG. 1. The method 200 may involve transmission of instructions and requests between the various components of the system 100.

The method 200 may be initiated when a user computer 104, a user mobile device 106 or a bank terminal 108 captures a unique banknote identifier 202 and a banknote monetary value 204 of a banknote 110 belonging to a user. In the example shown in FIG. 2, the unique banknote identifier 202 is “1234” and the banknote monetary value 204 is $10.

At 206, the unique banknote identifier 202 and the banknote monetary value 204 of the banknote 110 may be communicated to a banknote server 114 connected to a banknote database 116. A banknote record may be created to store the unique banknote identifier 202 and a value of the banknote 110. In the example shown in FIG. 2, the banknote record indicates that the value of the banknote 110 is the banknote monetary value of $10.

At 208, a first instruction may be sent from the user computer 104, the user mobile device 106 or the bank terminal 108 to the banknote server 114. In response to the first instruction, the banknote server 114 may detach the banknote monetary value from the banknote 110 by converting the banknote monetary value to a digital monetary value. Accordingly, the banknote record may be updated by changing the value of the banknote 110 to $0. As a result, use of the banknote 110 may be suspended and the banknote 110 may be unusable as payment at a Point-of-Sale (POS) terminal.

At 210, the banknote server 114 may send a credit request to a bank server 118 via a bank server interface. In response to the credit request, the bank account of the user may be accessed by a mobile banking application 120 integrated with a client-side currency conversion software application and the bank account of the user may be credited by the banknote monetary value of $10 which results in a balance of $10.

At 212, a second instruction may be sent from the user computer 104, the user mobile device 106 or the bank terminal 108 to the banknote server 114. In response to the second instruction, the banknote server 114 may restore the banknote monetary value to the banknote 110 by reverse converting the digital monetary value to the banknote monetary value. Accordingly, the banknote record may be updated by changing the value of the banknote 110 to $10. As a result, use of the banknote 110 may be reinstated and the banknote 110 may be usable as payment at a POS terminal.

At 214, the banknote server 114 may send a debit request to the bank server 118 via the bank server interface. In response to the debit request, the bank account of the user may be accessed by the mobile banking application 120 integrated with the client-side currency conversion software application and the bank account of the user may be debited by the banknote monetary value of $10 which results in a balance of $0.

In an embodiment of the present techniques, the method for currency conversion and banknote suspension and reinstatement may be implemented by instructions stored on at least one non-transitory computer-readable medium. These instructions may be read and executed by at least one processor to perform the functions described herein. For example, the instructions may direct the at least one processor to capture a unique banknote identifier and a banknote monetary value of a banknote belonging to a user via a user terminal.

Per the instructions, the at least one processor may be directed to store the unique banknote identifier, the banknote monetary value and a user identity in a banknote record on a banknote server. The method may continue when the at least one processor is directed to send a first instruction from the user terminal to the banknote server. The monetary banknote value may be detached from the banknote by converting the banknote monetary value to a digital monetary value when the first instruction is received by the banknote server. Accordingly, the at least one processor may be directed to update the banknote record on the banknote server.

The instructions may direct the at least one processor to send a credit request from the banknote server to a bank server. A bank account of the user may be stored on the bank server and the at least one processor may be directed to access the bank account using a mobile banking application integrated with a client-side currency conversion software application. The at least one processor may be directed to credit the bank account of the user by the banknote monetary value once the credit request has been received by the bank server and the bank account of the user has been accessed.

The method may continue when the at least one processor is directed to send a second instruction from the user terminal to the banknote server. The banknote monetary value may be restored to the banknote by reverse converting the digital monetary value to the banknote monetary value when the second instruction is received by the banknote server. Accordingly, the at least one processor may be directed to update the banknote record on the banknote server.

The instructions may direct the at least one processor to send a debit request from the banknote server to the bank server. Once again, the at least one processor may be directed to access the bank account of the user on the bank server using the mobile banking application integrated with the client-side currency conversion software application. The at least one processor may be directed to debit the bank account of the user by the banknote monetary value once the debit request has been received by the bank server and the bank account of the user has been accessed.

The embodiments disclosed herein may be implemented by the instructions stored on a tangible, non-transitory machine-readable medium. These instructions may be read and executed by a computing platform to perform the functions described above. A tangible, non-transitory machine-readable medium may include any tangible, non-transitory medium for storing information in a form readable by a machine, e.g., a computer. Examples of a tangible, non-transitory machine-readable medium may include read only memory (ROM), random access memory (RAM), magnetic disk storage media, optical storage media, flash memory devices or the like.

An embodiment is an implementation or example. The reference to “an embodiment” signifies that a particular component, function or instruction is included in at least one embodiment, but not necessarily in all embodiments, of the present techniques.

A component, function or instruction described and illustrated herein does not need to be included in a particular embodiment or embodiments. For example, if the specification states that a component, function or instruction “may” be included, that particular component, function or instruction is not required to be present. If the specification or a claim refers to “a” or “an” component, function or instruction, there is not necessarily only one of the component, function or instruction.

Some embodiments have been described by referring to particular implementations. However, other implementations are possible. The implementations of the present techniques are not limited to those disclosed herein. Additionally, the arrangement of the components and the sequence of the functions or instructions described above or illustrated in the drawings are not required to be arranged or sequenced in the particular manner described or illustrated. Other arrangements and sequences are possible.

Components or functions shown in the drawings may have the same reference number to suggest that the components or functions are similar. Alternatively, components or functions shown in the drawings may have different reference numbers to suggest that the components or functions are different. However, a component or function may be flexible enough to be present in some or all of the implementations described above or shown in the drawings. Various instructions described herein or depicted in the drawings may be referred to as a first instruction or a second instruction. It is arbitrary which instruction is designated the first instruction or the second instruction.

Details of an aforementioned example may apply to one or more embodiments. For instance, a method described above may be implemented by the instructions stored on the computer-readable medium. Furthermore, the embodiments of the present techniques are not limited to those embodiments described herein or shown in the drawings. For example, the sequences exemplified in the drawings do not need to progress in exactly the same order as illustrated.

The present techniques are not restricted to the particular details described herein. Those skilled in the art having the benefit of this disclosure will appreciate that many other variations of the foregoing descriptions and accompanying drawings are possible and remain within the scope of the present techniques. Accordingly, it is the following claims and any amendments thereto that define the scope of the present techniques.

1. A method for currency conversion and banknote suspension and reinstatement, comprising:
capturing a unique banknote identifier and a banknote monetary value of a banknote belonging to a user via a user terminal;
sending a first instruction from the user terminal to a banknote server;
detaching the banknote monetary value from the banknote, suspending use of the banknote and rendering the banknote unusable as payment at a Point-of-Sale (POS) terminal by converting the banknote monetary value to a digital monetary value when the first instruction is received by the banknote server;
sending a credit request from the banknote server to a bank server via a bank server interface;
crediting a bank account of the user by the banknote monetary value when the credit request is received by the bank server;
sending a second instruction from the user terminal to the banknote server;
restoring the banknote monetary value to the banknote, reinstating the use of the banknote and rendering the banknote usable as payment at the POS terminal by reverse converting the digital monetary value to the banknote monetary value when the second instruction is received by the banknote server;
sending a debit request from the banknote server to the bank server via the bank server interface; and
debiting the bank account of the user by the banknote monetary value when the debit request is received by the bank server.

2. The method of claim 1, comprising creating a banknote record and storing the banknote record on the banknote server, wherein the banknote record comprises the unique banknote identifier, the banknote monetary value and a user identity.

3-5. (canceled)

6. The method of claim 1, comprising updating the banknote record on the banknote server when the banknote monetary value is detached from the banknote and when the banknote monetary value is restored to the banknote.

7. The method of claim 1, wherein-the a client-side currency conversion software application is installed on the user terminal, the client-side currency conversion software application comprises a desktop application or a browser-based application when the user terminal is a user computer and the client-side currency conversion software application comprises a mobile device application when the user terminal is a user mobile device.

8-10. (canceled)

11. The method of claim 1, wherein the user terminal comprises a bank terminal, and the bank terminal comprises an Automated Teller Machine (ATM).

12. The method of claim 7, wherein the client-side currency conversion software application is integrated with a mobile banking application and the mobile banking application is used to access the bank account of the user.

13. The method claim 1, wherein the bank server interface comprises a front-end browser interface and a back-end server interface.

14. A system for currency conversion and banknote suspension and reinstatement, comprising:
a user terminal to
capture a unique banknote identifier and a banknote monetary value of a banknote belonging to a user and
send a first instruction and a second instruction; a banknote server to
detach the banknote monetary value from the banknote, suspend use of the banknote and render the banknote unusable as payment at a Point-of-Sale (POS) terminal by conversion of the banknote monetary value to a digital monetary value when the first instruction is received from the user terminal;
send a credit request:
restore the banknote monetary value to the banknote, reinstate the use of the banknote and render the banknote usable as payment at the POS terminal by a reverse conversion of the digital monetary value to the banknote monetary value when the second instruction is received from the user terminal; and
send a debit request; and
a bank server to
credit a bank account of the user by the banknote monetary value when the credit request is received from the banknote server and
debit the bank account of the user by the banknote monetary value when the debit request is received from the banknote server.

15-16. (canceled)

17. The system of claim 14, wherein the a client-side currency conversion software application is installed on the user terminal, the client-side currency conversion software application comprises a desktop application or a browser-based application when the user terminal is a user computer and the client-side currency conversion software application comprises a mobile device application when the user terminal is a user mobile device.

18-20. (canceled)

21. The system of claim 14, wherein the user terminal comprises a bank terminal, and the bank terminal comprises an Automated Teller Machine (ATM).

22. The system claim 17,wherein the client-side currency conversion software application is integrated with a mobile banking application and the mobile banking application is used to access the bank account of the user.

23. At least one non-transitory computer-readable medium, comprising instructions to direct at least one processor to:
capture a unique banknote identifier and a banknote monetary value of a banknote belonging to a user via a user terminal;
send a first instruction from the user terminal to a banknote server;
detach the banknote monetary value from the banknote and suspend use of the banknote by converting the banknote monetary value to a digital monetary value when the first instruction is received by the banknote server;
send a credit request from the banknote server to a bank server;
credit a bank account of the user by the banknote monetary value when the credit request is received by the bank server;
send a second instruction from the user terminal to the banknote server;
restore the banknote monetary value to the banknote and reinstate the use of the banknote by reverse converting the digital monetary value to the banknote monetary value when the second instruction is received by the banknote server;
send a debit request from the banknote server to the bank server; and
debit the bank account of the user by the banknote monetary value when the debit request is received by the bank server.

24-27. (canceled)

28. The system of claim 14, wherein a banknote record is created and stored on a banknote server and the banknote record comprises the unique banknote identifier, the banknote monetary value and a user identity.

29. The system of claim 14, wherein the banknote server is in data communication with the bank server via a bank server interface and the credit request and the debit request are sent from the banknote server to the bank server via the bank server interface.

30. The system of claim 29, wherein the bank server interface comprises a front-end browser interface and a back-end server interface.

31. The system of claim 14, wherein the banknote record is updated when the banknote monetary value is detached from the banknote and when the banknote monetary value is restored to the banknote.

32. The at least one non-transitory computer-readable medium of claim 23, comprising instructions to create a banknote record and store the banknote record on the banknote server, wherein the banknote record comprises the unique banknote identifier, the banknote monetary value and a user identity.

33. The at least one non-transitory computer-readable medium of claim 23, comprising instructions to update the banknote record when the banknote monetary value is detached from the banknote and when the banknote monetary value is restored to the banknote.

34. The at least one non-transitory computer-readable medium of claim 23, comprising instructions to access the bank account of the user via a mobile banking application integrated with a client-side currency conversion software application.
